(19) United States
(12) Patent Application Publication
(10) Pub. No.: US 2022/0347953 A1
(43) Pub. Date: Nov. 3, 2022

(54) METHOD FOR IMPROVING CEMENT SPRAYING EFFICIENCY FOR SELF-REPAIRING TIRE

(71) Applicant: SHANDONG LINGLONG TYRE CO., LTD., Zhaoyuan (CN)

(72) Inventors: Feng WANG, Zhaoyuan (CN); Caixin YANG, Zhaoyuan (CN); Dejian YANG, Zhaoyuan (CN); Yanhong LU, Zhaoyuan (CN); Lei TENG, Zhaoyuan (CN); Liyan ZHU, Zhaoyuan (CN); Dong CHEN, Zhaoyuan (CN)

(73) Assignee: SHANDONG LINGLONG TYRE CO., LTD., Zhaoyuan (CN)

(21) Appl. No.: 17/762,099

(22) PCT Filed: Mar. 29, 2021
(86) PCT No.: PCT/CN2021/083702

§ 371 Date: Mar. 21, 2022

(30) Foreign Application Priority Data
Mar. 31, 2020 (CN) 202010241612.5

(51) Int. Cl. B29D 30/06; B60C 19/12

(52) U.S. Cl. CPC B29D 30/0681; B60C 19/12; B29D 2030/0697

(57) ABSTRACT

A method for improving a cement spraying efficiency for a self-repairing tire includes: inputting tire parameters into a control system, including rim diameter, section width, aspect ratio, cement thickness and cement density; calculating a cement spraying amount for a tire; calculating a crown cement thickness separately; starting a spraying device, and evenly spraying a cement in a cement storage tank on a tire surface; and finally drying, that is, heating to speed up solidification of the cement, thereby completing self-repair. The control system automatically calculates the cement spraying amount required for repair based on the tire parameters such as section width, aspect ratio and rim diameter, and realizes mass production of self-repairing tires according to the characteristics of the tires. The method is applicable to all tires of different specifications, and can realize a one-time spraying operation, thereby improving the spraying efficiency for self-repairing tires.

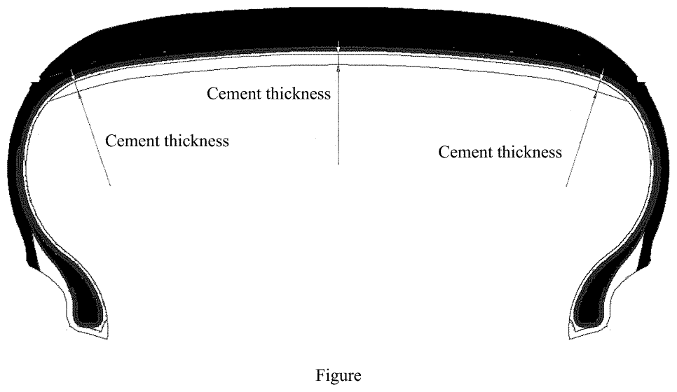

### CROSS REFERENCE TO THE RELATED APPLICATIONS

This application is the national phase entry of International Application No. PCT/CN2021/083702, filed on Mar. 29, 2021, which is based upon and claims priority to Chinese Patent Application No. 202010241612.5, filed on Mar. 31, 2020, the entire contents of which are incorporated herein by reference.

### TECHNICAL FIELD

The present disclosure relates to a process for adjusting a spraying amount, and in particular to a method for improving a cement spraying efficiency for a self-repairing tire.

### BACKGROUND

The tires inevitably wear out after a period of use and thus a cement is typically used to repair the tires.

For the existing spraying device, the spraying amount depends on the size and specifications of the tires. After each manual spraying, the operator needs to measure the spraying thickness and then adjusts the spraying amount for the next spraying according to the spraying thickness, until the inner spraying thickness of the tire reaches 5±0.5 mm. In summary, it is necessary to repeatedly adjust the spraying amount according to the spraying thickness during the spraying operation.

### SUMMARY

### Technical Problem

At present, before production, the spraying amount for each self-repairing tire is estimated prior to actual spraying, and the spraying is performed based on the spraying thickness and tire weight. The repeated operation to determine the spraying amount increases labor intensity and is not conducive to large-scale production.

### Solution to the Problem

In order to overcome the above-mentioned shortcomings in the prior art, the present disclosure provides a method for improving a cement spraying efficiency for a self-repairing tire.

To solve the above technical problem, the present disclosure adopts the following technical solution.

A method for improving a cement spraying efficiency for a self-repairing tire includes the following steps:

step 1: inputting tire parameters into a control system, including rim diameter, section width, aspect ratio, cement thickness and cement density;

step 2: calculating a cement spraying amount for a tire based on the tire parameters of the tire to be repaired in the control system;

step 3: setting a crown cement parameter, setting a crown cement thickness in the control system, calculating an average cement thickness based on the cement spraying amount calculated by the control system in step 2, and adding 0.1-5 mm to the average cement thickness to serve as the crown cement thickness;

step 4: connecting the control system to a spraying device, and inputting the average cement thickness and the crown cement thickness acquired by the control system into the spraying device;

step 5: filling a cement storage tank of the spraying device with a sufficient amount of cement;

step 6: mounting the tire to be repaired in the spraying device, and moving the tire to be repaired to a repair station;

step 7: starting the spraying device; and evenly spraying, by a spray gun of the spraying device, the cement in the cement storage tank on a tire surface, and spraying a circle of cement with a thickness of 0.1-5 mm higher than the average cement thickness at a crown; and

step 8: drying and heating the sprayed tire to speed up solidification of the cement, and unloading the tire after the cement is solidified. Beneficial Effects of the Disclosure

Compared with the prior art, the present disclosure has the following advantages:

In the present disclosure, the control system automatically calculates the cement spraying amount required for repair based on the tire parameters such as section width, aspect ratio and rim diameter, and realizes mass production of self-repairing tires according to the characteristics of the tires. The present disclosure is applicable to all tires of different specifications, and can realize a one-time spraying operation, thereby improving the spraying efficiency for self-repairing tires. The present disclosure avoids repeated operations to adjust the spraying amount for tire repair in the prior art, thereby solving the problems of low production efficiency, low automation level and poor quality control of self-repairing tires, and facilitating the large-scale production of self-repairing tires.

### BRIEF DESCRIPTION OF THE DRAWINGS

The FIGURE shows spraying positions at a crown of a tire.

### DETAILED DESCRIPTION OF THE EMBODIMENT

Implementations of the Disclosure

In order to facilitate the understanding of the present disclosure, the present disclosure is described more completely below with reference to the accompanying drawings. The drawings show preferred embodiments of the disclosure. However, the present disclosure may be embodied in various forms without being limited to the embodiments described herein. These embodiments are provided for a more thorough and comprehensive understanding of the present disclosure.

In addition, it should be noted that when a component is “fixed” or “provided” on the other component, the component may be fixed on the other component directly or via an intermediate component. When a component is connected with the other component, the component may be connected with the other component directly or via an intermediate component. The terms “vertical”, “horizontal”, “left”, and “right” and similar expressions used herein are just for illustrative purposes, and do not mean sole implementations.

Referring to the FIGURE, an embodiment of the present disclosure provides a method for improving a cement spraying efficiency for a self-repairing tire, including the following steps:

Step 1: tire parameters are input into a control system, including rim diameter, section width, aspect ratio, cement thickness and cement density.

Step 2: Calculate a cement spraying amount for a tire based on the tire parameters of the tire to be repaired in the control system.

Step 3: A crown cement parameter and a crown cement thickness are set in the control system; an average cement thickness is calculated based on the cement spraying amount calculated by the control system in step 2, and 0.1-5 mm is added to the average cement thickness to serve as the crown cement thickness, so as to prevent the crown from leaking after a puncture.

Step 4: The control system is connected to a spraying device, and the average cement thickness and the crown cement thickness acquired by the control system are input into the spraying device.

Step 5: A cement storage tank of the spraying device is filled with a sufficient amount of cement.

Step 6: The tire to be repaired is mounted in the spraying device, and the tire is moved to be repaired to a repair station.

Step 7: The spraying device is started; and a spray gun of the spraying device evenly sprays the cement in the cement storage tank on a tire surface, and sprays a circle of cement with a thickness of 0.1-5 mm higher than the average cement thickness at a crown.

Step 8: The sprayed tire is dried and heated to speed up solidification of the cement, and the tire after the cement is solidified is unloaded to complete self-repair.

In an embodiment of the present disclosure, the spraying device is provided with a control panel digitally connected to a host of the spraying device; the control panel is a touch screen; and the control panel is signal-connected to the control system.

The control system calculates and writes the cement spraying amount for the tire into the control panel, and sends an instruction through the control panel to unload the tire or move the tire to the repair station.

In another embodiment of the present disclosure, the spraying device is provided with a fixture for fixing the tire; the fixture is used to clamp a rotation center of the tire; and the fixture is provided with a cylinder for adjusting a tire station.

The cylinder drives the fixture to move the tire to be repaired to a designated position, including the repair station and a mounting station.

In another embodiment of the present disclosure, a roll motor is provided on the fixture;

the roll motor is signal-connected to the control panel; and an output end of the roll motor is connected to the fixture and is located on the same straight line with the rotation center of the tire.

The roll motor drives the tire to rotate, so as to realize circumferential spraying of the tire surface.

In another embodiment of the present disclosure, in step 2, the control system calculates the cement spraying amount for the tire to be repaired as follows:

spraying amount=[rim diameter/2*25.4+section width/aspect ratio*100]*6.28*section width*cement thickness*cement density.

In another embodiment of the present disclosure, the spraying device is provided with a pump connected to the cement storage tank; the pump is connected to the spray gun used in step 7; the spray gun is provided with an atomizing nozzle for atomizing the cement into particles; and the pump is signal-connected to the control panel.

When the spraying work is started on the control panel, the control panel sends a spraying signal to the pump, and the pump sprays the cement in the cement storage tank from the spray gun and the atomizing nozzle.

In another embodiment of the present disclosure, the control panel is provided with an automatic spraying module and a manual spraying module, which are signal-connected to the roll motor.

When automatic spraying is started, the roll motor automatically drives the tire to be repaired to rotate, so as to realize automatic circumferential spraying. After manual spraying is started, the roll motor is manually controlled to work, which is convenient for multiple spraying at positions with serious lack of cement on the tire.

It should be emphasized here that the present disclosure solves the problems existing in the prior art. At present, during tire repair, the spraying amount varies with the size of the tires. During manual spraying, it is necessary to measure the spraying thickness after first spraying and adjust the spraying amount accordingly for second spraying until the inner spraying thickness of the tire reaches 5±0.5 mm. The present operation is cumbersome, laborious, inefficient, and is not conducive to large-scale production.

### INDUSTRIAL APPLICABILITY

The above described are the preferred embodiments of the present disclosure, which should not be construed as a limitation to the claims. The present disclosure is not limited to the above embodiments, and changes may be made to the specific structure of the present disclosure. Any changes made within the protection scope of the independent claims of the present disclosure should fall within the protection scope of the present disclosure.

Unless otherwise defined, all technical and scientific terms used herein have the same meaning as commonly understood by those skilled in the technical field of the present disclosure. The terms used in the specification of the present disclosure herein are only for the purpose of describing specific embodiments, and are not intended to limit the present disclosure. The term “and/or” used herein includes any and all combinations of one or more of the associated listed items.

What is claimed is:

1. A method for improving a cement spraying efficiency for a self-repairing tire, comprising the following steps:
step 1: inputting tire parameters into a control system, wherein the tire parameters comprise a rim diameter, a section width, an aspect ratio, a cement thickness and a cement density;
step 2: calculating a cement spraying amount for a tire based on the tire parameters of the tire to be repaired in the control system;
step 3: setting a crown cement parameter, and setting a crown cement thickness in the control system, wherein the crown cement thickness is obtained by the following: calculating an average cement thickness based on the cement spraying amount calculated by the control system in step 2, and adding 0.1-5 mm to the average cement thickness to serve as the crown cement thickness;
step 4: connecting the control system to a spraying device, and inputting the average cement thickness and the crown cement thickness acquired by the control system into the spraying device;
step 5: filling a cement storage tank of the spraying device with a cement;
step 6: mounting the tire to be repaired in the spraying device, and moving the tire to be repaired to a repair station;
step 7: starting the spraying device; and allowing a spray gun of the spraying device to evenly spray the cement in the cement storage tank on a tire surface, and spraying a circle of cement with a thickness of 0.1-5 mm higher than the average cement thickness at a crown; and
step 8: drying and heating the tire after the spraying to speed up solidification of the cement, and unloading the tire after the cement is solidified.

2. The method according to claim 1, wherein the spraying device is provided with a control panel digitally connected to a host of the spraying device; the control panel is signal-connected to the control system; and the control system calculates the cement spraying amount for the tire and writes the cement spraying amount into the control panel.

3. The method according to claim 2, wherein the spraying device is provided with a fixture for fixing the tire; the fixture clamps a rotation center of the tire; and the fixture is provided with a cylinder for adjusting the repair station.

4. The method according to claim 3, wherein a roll motor is provided on the fixture; the roll motor is signal-connected to the control panel; and an output end of the roll motor is connected to the fixture and is located on the same straight line with the rotation center of the tire.

5. The method according to claim 1, wherein in step 2, the control system calculates the cement spraying amount for the tire to be repaired by the following equation:
spraying amount=[rim diameter/2*25.4+section width/aspect ratio*100]*6.28*section width*cement thickness*cement density.

6. The method according to claim 2, wherein the spraying device is provided with a pump connected to the cement storage tank; the pump is connected to the spray gun used in step 7; the spray gun is provided with an atomizing nozzle for atomizing the cement into particles; and the pump is signal-connected to the control panel.

7. The method according to claim 4, wherein the control panel is provided with an automatic spraying module and a manual spraying module, and the automatic spraying module and the manual spraying module are both signal-connected to the roll motor.
